(19) United States
(12) Patent Application Publication
(10) Pub. No.: US 2007/0100940 A1
(43) Pub. Date: May 3, 2007

(54) Systems and methods for implementing a single-number follow me service for videoconferencing

(75) Inventor: Andreas Eriksson, West Milford, NJ (US)

Correspondence Address: MORRISON & FOERSTER LLP, 1650 TYSONS BOULEVARD, SUITE 300, MCLEAN, VA, 22102, US

(73) Assignee: Glowpoint, Inc., Hillside, NJ (US)

(21) Appl. No.: 11/509,820

(22) Filed: Aug. 25, 2006

Related U.S. Application Data
(60) Provisional application No. 60/710,942, filed on Aug. 25, 2005.

(51) Int. Cl. G06F 15/16

(52) U.S. Cl. 709/204

(57) ABSTRACT

A conferencing system and method having, a conferencing unit to initiate a remote conference, wherein the remote conference is initiated by inputting a conferencing identifier into the conferencing unit; more than one client associated with the conferencing identifier; and a conference network device to determine which of the clients has an active connection to the conferencing system; wherein the remote conference is established between the conferencing unit and one of the clients based on the determination of the conference network device.

### CROSS-REFERENCE TO RELATED APPLICATIONS

This application claims the benefit of U.S. Provisional Application Ser. No. 60/710,942, filed Aug. 25, 2005.

### BACKGROUND OF THE INVENTION

In today's fast paced business world face to face meetings are being replaced by remote conferencing. Businesses have found video conferencing to be among the most effective methods of remote conferencing. By using video conferencing technology two remote parties are able to sit down and look each other in the eye while being hundreds or thousands of miles apart.

One of the historical drawbacks of video conferencing technology is that, partially due to the price and configuration of the equipment, the parties using the technology were confined to specific locations that supported video conferencing. However, a recent trend has emerged wherein video conferencing systems have become easier to establish, thereby allowing for multiple access points for a given user. Additionally, the video conferencing systems have begun to utilize mobile conferencing hardware such as mobile software clients.

With this increasing trend, a new difficulty has emerged; it has become more common for a specific user to use multiple video contact clients. As a result, it has become increasingly cumbersome to establish remote conferences.

### BRIEF SUMMARY OF THE INVENTION

According to various embodiments of the invention, a conferencing system may comprise: a conferencing unit to initiate a remote conference, wherein the remote conference is initiated by inputting a conferencing identifier into the conferencing unit; a plurality of clients associated with the conferencing identifier; and a conference network device to determine which of the plurality of clients has an active connection to the conferencing system; wherein the remote conference is established between the conferencing unit and one of the plurality of clients based on the determination of the conference network device.

According to various embodiments of the invention, the conferencing identifier is a phone number.

According to various embodiments of the invention, at least one of the clients is a room system.

According to various embodiments of the invention, at least one of the clients is a laptop computer.

According to various embodiments of the invention, the conference network device comprises a registry having a rule-set to determine which of the plurality of clients the conference is established with if more than one client has an active connection to the conference system.

According to various embodiments of the invention, at least one of the clients is a mobile telephone.

According to various embodiments of the invention, the conference is established via the internet.

According to various embodiments of the invention, the conference is established via an H.323 backbone.

According to various embodiments of the invention, the registry is an SQL database.

According to various embodiments of the invention, the conference is a video conference.

According to various embodiments of the invention, a method of establishing a conference may comprise: inputting a conference identifier into a conferencing device; determining which of a plurality of clients associated with the conferencing identifier has an active connection to a conferencing network; establishing a conference with one of the plurality of clients which has an active connection to a conferencing network.

According to various embodiments of the invention, a method of establishing a conference may further comprise determining which of the plurality of clients a conference is to be established with based on a rule-set of a registry when more than one client has an active connection to the conferencing network.

### BRIEF DESCRIPTION OF THE DRAWINGS

FIG. 1 depicts an exemplary remote conferencing system, according to various embodiments of the invention.

FIG. 2 depicts an exemplary flowchart for processing an incoming conferencing call and/or request, according to various embodiments of the invention.

FIG. 3 depicts an exemplary system structure of a video conferencing system, according to various embodiments of the invention.

### DETAILED DESCRIPTION OF THE INVENTION

According to various embodiments of the invention, a remote conferencing system is equipped with a “follow me” capability. The follow me capability allows subscribers using stationary or mobile conferencing hardware and systems to be contacted using a single conferencing identifier. According to various embodiments of the invention, this conferencing identifier may be referred to as a phone number or even simply a number; however, these terms are not intended to limit the conferencing identifier to a standard seven or ten digit number. It would be understood by one of ordinary skill in the art that the conferencing identifier may be any sort of identifier that allows a specific user to be identified by a conferencing system. The phone number may be used to contact a subscriber using various clients, including, but not limited to, a stationary room system client, a desktop software client, and a mobile software client.

According to various embodiments of the invention, a network may be configured to allow a phone number to “follow” a user when, for example, the user leaves the office with a laptop. A user may have a preferred conferencing client, such as a client in the user's home office, that the user may use for most conferencing applications, this client may be referred to as a primary subscriber client. When the user is in the home office, the user may prefer all incoming conference requests and/or calls to be sent to the primary subscriber client.

However, when the user leaves the home office and travels to an alternate office, or when the user travels with a mobile client, the user may prefer to receive incoming conferencing requests and/or calls at an alternate location. According to various embodiments of the invention, a system is provided to allow the user to be located and contacted using the same conferencing identifier regardless of the user's location and the client the user is using.

According to various embodiments of the invention, when the user launches a mobile client from a laptop at a remote location, for example a hotel lobby or coffee shop, the system establishes the identity of the mobile client and/or the user. The system then recognizes that the user is connected to a client other than the primary subscriber client and establishes that a secondary subscriber client is active. Accordingly, when a caller dials the user's number (or otherwise inputs a conferencing identifier linked to the user), the system determines whether a secondary subscriber client is established in addition to, or instead of, the subscriber's primary client. If a secondary client has been established, then the conference may be routed to the secondary client. If a secondary client has not been established, the conference call may be routed to the primary client and/or to a mailbox system.

According to various embodiments of the invention, the establishing of primary and/or secondary clients may be transparent to the caller such that the caller may not be aware which client the user is using. By providing a transparent system to the caller, various embodiments of the invention provide a more efficient and user friendly system and method of establishing and conducting remote conferencing.

According to various embodiments of the invention, a remote conferencing system is equipped with a “follow me” capability. The follow me capability allows subscribers using stationary or mobile conferencing hardware and systems to be contacted using a single conferencing identifier. According to various embodiments of the invention, this conferencing identifier may be referred to as a phone number or even simply a number; however, these terms are not intended to limit the conferencing identifier to a standard seven or ten digit number. It would be understood by one of ordinary skill in the art that the conferencing identifier may be any sort of identifier that allows a specific user to be identified by a conferencing system. The phone number may be used to contact a subscriber using various clients, including, but not limited to, a stationary room system client, a desktop software client, and a mobile software client.

According to various embodiments of the invention, a network may be configured to allow a phone number to “follow” a user when, for example, the user leaves the office with a laptop. A user may have a preferred conferencing client, such as a client in the user's home office, that the user may use for most conferencing applications, this client may be referred to as a primary subscriber client. When the user is in the home office, the user may prefer all incoming conference requests and/or calls to be sent to the primary subscriber client.

However, when the user leaves the home office and travels to an alternate office, or when the user travels with a mobile client, the user may prefer to receive incoming conferencing requests and/or calls at an alternate location. According to various embodiments of the invention, a system is provided to allow the user to be located and contacted using the same conferencing identifier regardless of the user's location and the client the user is using.

According to various embodiments of the invention, when the user launches a mobile client from a laptop at a remote location, for example a hotel lobby or coffee shop, the system establishes the identity of the mobile client and/or the user. The system then recognizes that the user is connected to a client other than the primary subscriber client and establishes that a secondary subscriber client is active. Accordingly, when a caller dials the user's number (or otherwise inputs a conferencing identifier linked to the user), the system determines whether a secondary subscriber client is established in addition to, or instead of, the subscriber's primary client. If a secondary client has been established, then the conference may be routed to the secondary client. If a secondary client has not been established, the conference call may be routed to the primary client and/or to a mailbox system.

According to various embodiments of the invention, the establishing of primary and/or secondary clients may be transparent to the caller such that the caller may not be aware which client the user is using. By providing a transparent system to the caller, various embodiments of the invention provide a more efficient and user friendly system and method of establishing and conducting remote conferencing.

According to various embodiments of the invention, a user may have access to both a home system and a mobile system. A home system may typically be located in a room, such as an office video conferencing room, while a mobile system may be more easily transported. A mobile system could be a video conferencing client such as that described in co-pending Application No. 60/685,375 titled “Simplified Interface for Live Operator Invocation,” which is hereby incorporated by reference.

According to one embodiment of the invention, a user may receive incoming calls directed to a single associated videoconferencing phone number while at any location from which the video conference network is accessible. When the user arrives at a network point of presence, the user can establish a secondary client by logging into the network with a unique identifier and/or a password combination. The unique identifier could be, for example, a name, an email, a phone number, a PIN, or any other unique identifier or URI. The network may then automatically store the user's new location information, e.g. address, with the user's entry in a Registrar.

In some embodiments, in response to a log in, the system can notify the user that a follow me feature has been activated, or that a secondary client has been established. The message sent to the subscriber could be in the form of a text message, speech, video programming, or any other form of communication.

According to various embodiments of the invention, when a user logs in to the network, the subscriber's Internet Protocol (IP) address may be transmitted to the Registrar, which identifies the user's identity and IP address and compares the received IP address to the IP address stored as the subscriber's primary IP address. If the incoming IP address does not match the stored primary address, the Registrar may then add or updates a record indicating the secondary IP address of the client user. The new IP address may then be stored as a second address in a database by the Registrar. According to various embodiments of the invention, the network routing system may be configured to look to any addresses in the database and route calls to that address. In another embodiment of the invention, the network routing system may be configured to select the most recently updated address.

According to various embodiments of the invention, the Registrar may perform automatic location registration functions. For example, the server can determine both the current IP location of the subscriber as well as the identity of the subscriber automatically in response to receiving the login information from the subscriber.

When a call destined for the subscriber arrives at a router, the Registrar may first check the received directory number to determine if a second IP address has been stored. In some embodiments of the invention, the Registrar can then redirect the call to the new location using the stored location information.

In one embodiment of the invention, a subscriber accesses the network from a Session Initiation Protocol (SIP) or H.323 compatible device. Network systems may store the address of the originating user device and may redirect incoming calls to that device. The system may be configured so that this redirection is performed until the user logs off the network or logs on to the network from a different or new location.

In further embodiments of the invention, the manner and sequence in which the activities of the system may be controlled by profile information associated with a subscriber.

As non-limiting examples, four possible call scenarios are illustrated below.

H.323 to H.323

H.323 to SIP

SIP to H.323

SIP to SIP

In cases 1 and 2, a Gatekeeper can ask an API service how to route the call. The API service can dynamically determine if the call should go to the primary system or to the secondary system. The API service then replies to the Gatekeeper with the correct routing.

In cases 3 and 4, the SIP registrar first checks its own registry to see if a desktop client is launched. If the client is launched and registered, it connects the call. If it is not registered, it will send the call through a Gateway to the H.323 side. The Gatekeeper will then route the call with the help of the API service as in cases 1 and 2. Additionally, a registrar or redirect server can be configured to receive a SIP request for a connection to a particular phone number and, in response, send an alternate number to the requesting client.

While the above description is provided with reference to Internet Protocol (IP) networks, one of ordinary skill in the art would recognize that other types of networks and protocols that provide for the individual addressability of communications endpoints could also be used.

The terms “subscriber” and “user” have been used interchangeably throughout the specification and should be interpreted to have a substantially similar meaning unless the context in which the term is used would indicate otherwise to one of ordinary skill in the art.

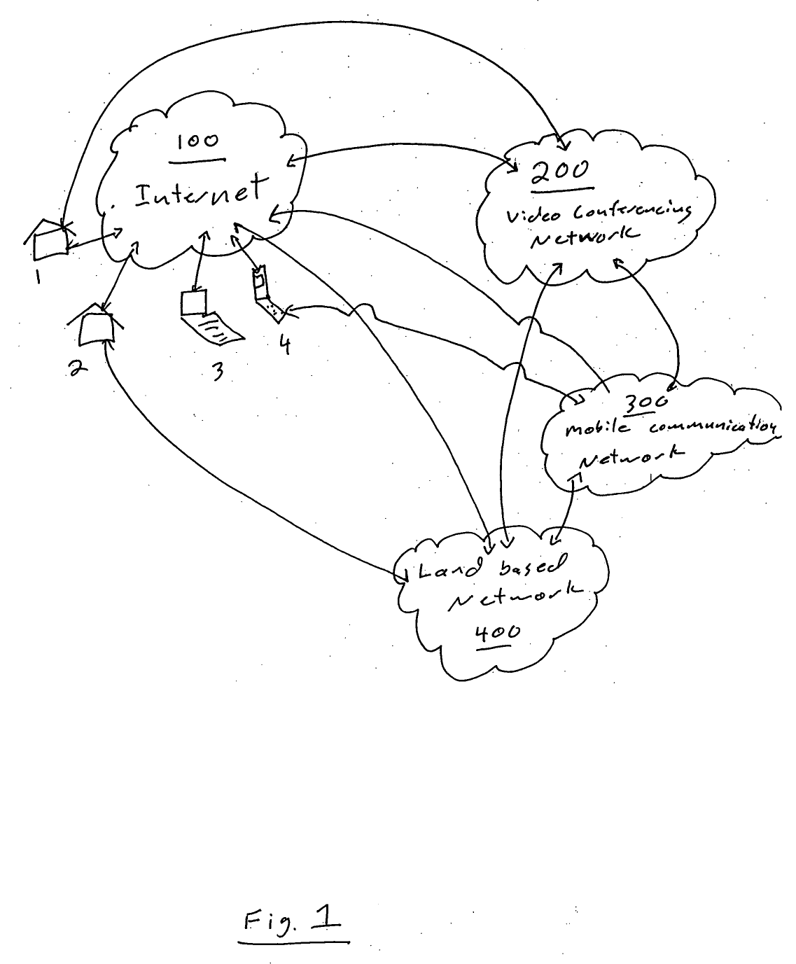

FIG. 1 depicts an exemplary remote conferencing system, according to various embodiments of the invention. As shown in FIG. 1, a user may conduct a remote conference using a home office client 1, a secondary office client 2, a mobile client 3 (such as a laptop), and/or a mobile client 4 (such as a mobile phone). One of ordinary skill in the art would realize that the clients shown are merely examples of remote conferencing clients and do not form a comprehensive list of possible clients or client types; any type of client capable of supporting a remote conference may be used in the exemplary embodiments depicted by FIG. 1.

As further shown in FIG. 1, a client 1-4 may be connected with a caller 500 in several ways. For example, when the caller 500 dials a user's phone number, the caller 500 may establish a remote conference through several paths, examples of which are depicted in FIG. 1. According to various embodiments of the invention, the caller 500 may connect to a traditional communications network 400 (i.e., a PBX), a mobile communications network 300, the video conferencing network 200, or to the internet 100. Depending on which network is used initially, further communication may be established between the caller 500 and the video conferencing network 200. For example, if the caller 500 uses a mobile client, the mobile client may initially establish contact with a mobile communications network 300, the call may then be routed from the mobile communications network to the videoconferencing network 200, which may in turn rout the communication through any of the previously listed networks, or even directly to one of the clients.

In an exemplary embodiment of the invention, a caller 500 using a stationary video conferencing system may directly contact the video conferencing network 200. Although the user being contacted has a primary client established a home office client 1, the video conferencing network 200 then may determine that a user has established a secondary client using a laptop computer 3. Accordingly, instead of connecting to the primary client, the video conferencing system 200 may instead contact the secondary client laptop 3 via the internet 100. Consequently, the caller 500 is be transparently connected with the user at the secondary client laptop 3.

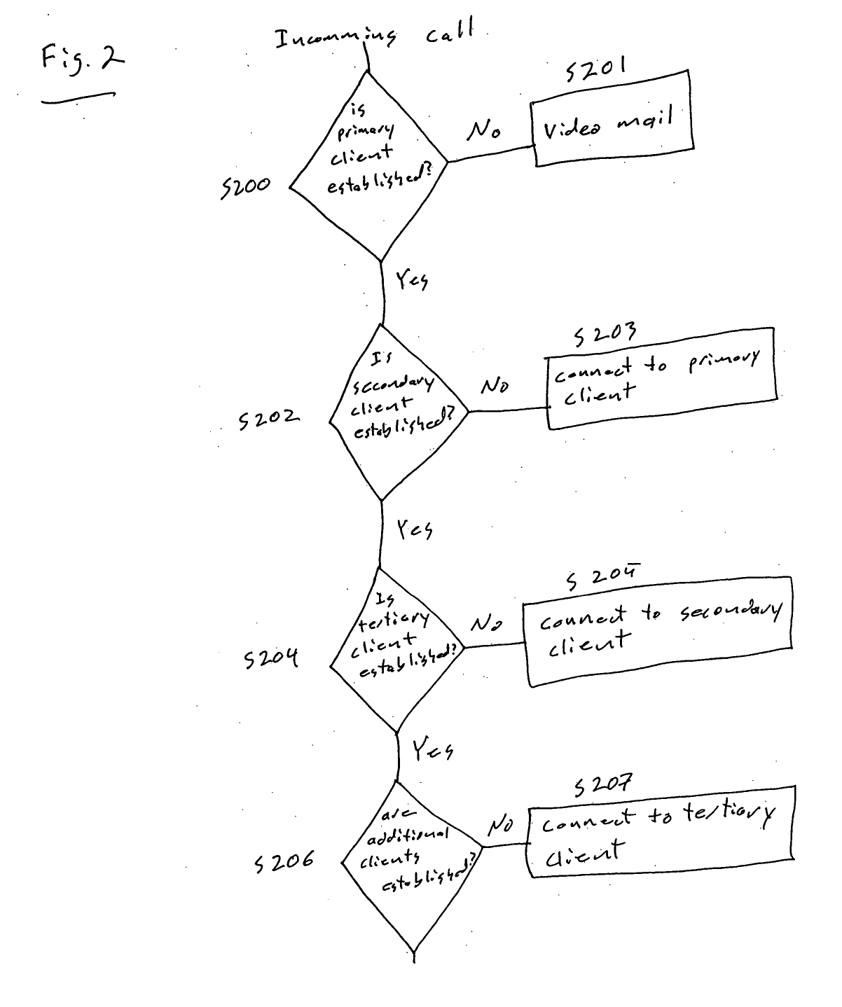

FIG. 2 depicts an exemplary flowchart for processing an incoming conferencing call and/or request, according to various embodiments of the invention. According to various embodiments of the invention, when the video conferencing system receives an incoming call or request the system determines whether or not a primary client is established S₂₀₀. If a primary client is not established, the call or request may be routed to a video mail system or terminated S201. If a primary client is established, the video conferencing system then determines if a secondary client is established S202. If a secondary client is not established, the call is connected to the primary client 203. If a secondary client is established, the video conferencing system then determines if a tertiary client is established S204. If a tertiary client is not established, the call is connected to the secondary client 205. If a tertiary client is established, the video conferencing system then determines if additional clients are established in a similar manner S206. If additional clients are not established, the call is connected to the tertiary client 207.

According to various embodiments of the invention, different methods may be used to determine which client the video conferencing system should establish a connection with. For example, the system may maintain a registry which indicates when a client is connected to the system and what user is associated with that client. Accordingly, when a caller attempts to establish a conference, the system may either establish the connection with a client if one is connected, or, if no client is connected, the system may connect the caller to a messaging system.

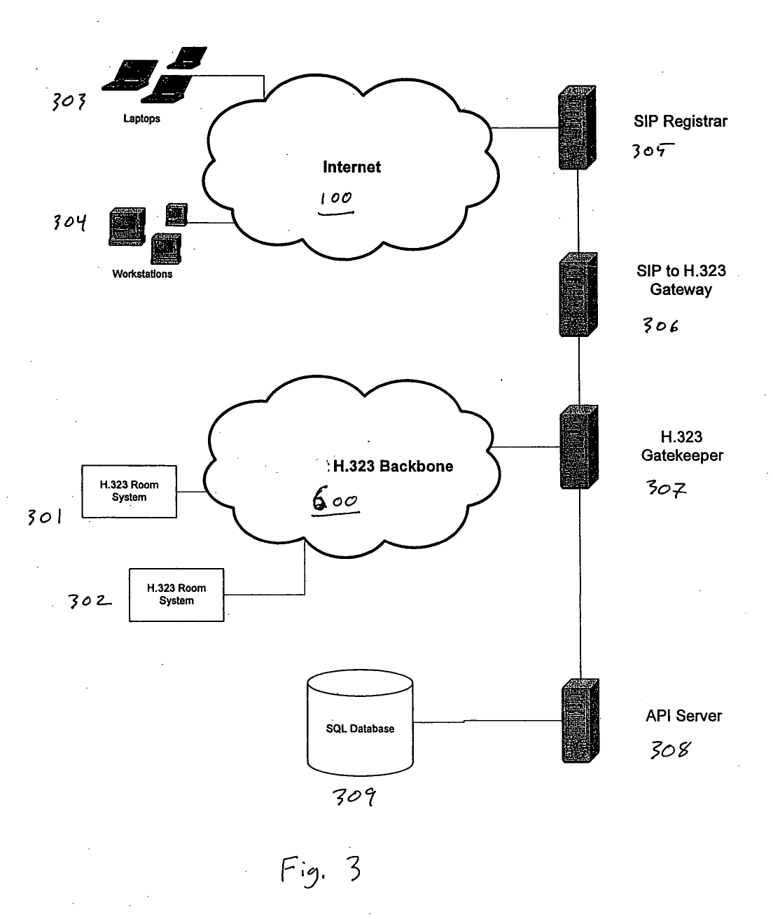

FIG. 3 depicts an exemplary system structure of a video conferencing system, according to various embodiments of the invention. As shown in FIG. 3, clients, such as H.323 Room Systems 301, 302 may be connected directly to a Backbone 600, while additional clients, i.e., laptops 303 and workstations 304, may be connected to the internet 100. The laptops 303 and workstations 304 may connect to the backbone 600 through an SIP registrar 305, a SIP to H.323 Gateway 306 and an H.323 Gatekeeper 307. Once a connection with the Backbone 600 is established, the laptops 303 and/or workstations 304 may establish a conference with an H.323 room system 301, 302. If desired, an SQL database 309 may be accessed from the H.323 Gateway 307 via an API server 308.

Although several exemplary embodiments of the invention have been described, these embodiments are not intended to be exhaustive or to limit the scope of the invention.

We claim:

1. A conferencing system, comprising:
a conferencing unit to initiate a remote conference, wherein the remote conference is initiated by inputting a conferencing identifier into the conferencing unit;
a plurality of clients associated with the conferencing identifier; and
a conference network device to determine which of the plurality of clients has an active connection to the conferencing system;
wherein the remote conference is established between the conferencing unit and one of the plurality of clients based on the determination of the conference network device.

2. The system of claim 1, wherein the conferencing identifier is a phone number.

3. The system of claim 1, wherein at least one of the clients is a room system.

4. The system of claim 1, wherein at least one of the clients is a laptop computer.

5. The system of claim 1, wherein the conference network device comprises a registry having a rule-set to determine which of the plurality of clients the conference is established with if more than one client has an active connection to the conference system.

6. The system of claim 1, wherein at least one of the clients is a mobile telephone.

7. The system of claim 1, wherein the conference is established via the internet.

8. The system of claim 1, wherein the conference is established via an H.323 backbone.

9. The system of claim 5, wherein the registry is an SQL database.

10. The system of claim 1, wherein the conference is a video conference.

11. A method of establishing a conference, comprising:
inputting a conference identifier into a conferencing device;
determining which of a plurality of clients associated with the conferencing identifier has an active connection to a conferencing network;
establishing a conference with one of the plurality of clients which has an active connection to a conferencing network.

12. The method of claim 11, further comprising: determining which of the plurality of clients a conference is to be established with based on a rule-set of a registry when more than one client has an active connection to the conferencing network.

13. The method of claim 11, wherein the conferencing identifier is a telephone number.

14. The method of claim 11, wherein at least one of the clients is a room system.

15. The method of claim 11, wherein at least one of the clients is a laptop computer.

16. The method of claim 11, wherein at least one of the clients is a mobile telephone.

17. The method of claim 11, wherein the conference is established via the internet.

18. The method of claim 11, wherein the conference is established via an H.323 backbone.

19. The method of claim 12, wherein the registry is an SQL database.

20. The method of claim 11, wherein the conference is a video conference.
